(19) United States
(12) Patent Application Publication
(10) Pub. No.: US 2007/0000193 A1
(43) Pub. Date: Jan. 4, 2007

(54) Storm panel mounting assembly

(76) Inventors: Brian Beaupre, Fruit Cove, FL (US); William R. Gellatly, Jacksonville Beach, FL (US)

Correspondence Address: Lawrence R. Radanovic, Esq., 3565 Brandywine Street, N.W., Washington, DC, 20008, US

(21) Appl. No.: 11/478,116

(22) Filed: Jun. 30, 2006

Related U.S. Application Data
(60) Provisional application No. 60/695,432, filed on Jul. 1, 2005.

(51) Int. Cl. E06B 3/26

(52) U.S. Cl. 52/202

(57) ABSTRACT

Channel members for mounting a storm panel over glass windows and doors are incorporated within the window and door trim members, headed bolts being contained within the channels by the bolt heads with their shanks extending through an open slot of the channel member and extending through apertures located at the upper and lower ends of a storm panel for mounting the panel in place. Nuts or the like are threaded over the threaded bolt shanks for securing the storm panel to the trim members.

### RELATED APPLICATION

Priority is claimed based on provisional application No. 60/695,432, filed Jul. 1, 2005.

### BACKGROUND OF THE INVENTION

This invention relates generally to an assembly for mounting storm panels over glass openings such as window and door structures of a building structure, and more particularly to such an assembly having elongated channel members for supporting bolts utilized to quickly mount the storm panels in place, the channels being integrated with the window/door trim members mounted on the building structure at least above and below the window/door structures.

Storm panels are typically provided for protecting glass openings of a building structure, such as windows, entry doors, sliding glass doors, etc., from damage which may result from high winds and flying debris experienced during storms such as a tropical depression or hurricane. The storm panels are typically mounted using threaded fasteners or nails driven directly through the siding of the building whereafter the storm panels are removed by withdrawing the nails or screws after the storm passes. This may result in the likelihood of permanent damage to the building siding by the nail or screw holes causing leakage of water and air which is undesirable, unless the holes are patched or caulked each time the storm panel is removed. Besides, this is most labor intensive for the installer and presents unsafe conditions for the installer during both the panel installation and panel removal process, especially when working on a ladder for covering glass openings inaccessible from the ground. In each case the installer must use a hammer or drill for applying the nails or screws with one hand while supporting the storm panel with the other or with the assistance of another which, especially during a wind gale, is laborious and unsafe. Even if the nail/screw holes are patched or caulked, the siding is damaged and rendered unsightly.

To expedite the mounting process, channel members have been provided for mounting the storm panels in place, the channels typically being mounted directly onto the building siding both above and below the window opening. Bolts are slid through open ends of the channels and their shanks extend through channel slots, mating with peripheral holes formed along the upper and lower edges of the panel after which nuts or other fasteners are engaged over the bolts for securing the panel in place. The drawback with such a system is that the channel members which may remain in place year round are not only unsightly but likewise create leakages through the nail holes or screw holes formed when mounting the channel members in place. The channel members can be removed when not in use but, again, the holes formed in the siding by the channel member fasteners must be patched or caulked, presenting an undesirable and unsightly condition.

### SUMMARY OF THE INVENTION

It is therefore an object of the present invention to provide an assembly for mounting storm panels over glass openings of a building structure utilizing channel members with bolts for attaching the storm panels wherein the channel members are fastened in such a manner as to avoid damage to the siding, thereby avoiding the aforementioned drawbacks and disadvantages in known storm panel mounting procedures.

In accordance with the present invention, the channel members are integrated with the door/window trim members, normally provided at least above and below the window/door openings such that the channels members are generally obscured from view and, more importantly, the channel members are never fastened to the siding but rather directly to the building structure which is typical when mounting door and trim members in place. Therefore, the integrity of the building is assured as the trim members with the integrated channel members are first mounted on the outer surface of the building before the building is faced with the siding. Some of the same fasteners used in securing the trim members in place are utilized for securing the channel members to the building structure, after which the joints between the trim members and siding are caulked to prevent water leakage behind the trim members and siding. Bolts are slid along open slots of the channel members from an open end or ends of the members with the heads contained within the channels while the bolt shanks extend through the slots and through openings provided in the storm panels at the upper and lower ends thereof after which nuts or the like are engaged with the bolt shanks for securely mounting the storm panels in place.

Other objects, advantages and novel features of the invention will become more apparent from the following detailed description of the invention when taken in conjunction with the accompanying drawings.

### BRIEF DESCRIPTION OF THE DRAWINGS

FIG. 1 is a plan view of one embodiment of a window structure of a building showing a storm panel, partly broken away, mounted in place in accordance with the invention;

FIG. 2 is a sectional view taken substantially along the line 2-2 of FIG. 1;

FIG. 3 is an enlarged sectional view of one embodiment of the invention taken substantially along the line 3-3 of FIG. 1;

FIG. 3A is a view similar to FIG. 3 showing another embodiment of the invention;

FIG. 4 is an enlarged sectional view taken substantially along the line 4-4 of FIG. 1;

FIG. 5 is a perspective view, at an enlarged scale, exemplifying an apertured thin strip member within the channel member for maintaining the bolts at a predetermined spaced apart distance;

FIG. 6 is a sectional view showing the storm panel as mounted in place utilizing the spacing strip of FIG. 5;

FIG. 7 is a plan view of an embodiment of an upper window adjacent the eave of a building structure with the storm panel mounted in place in accordance with the invention;

FIG. 8 is a sectional view taken substantially along the line 8-8 of FIG. 7;

FIG. 9 is a plan view of another embodiment of a window structure showing the upper and lower panels integrated within the trim members; and

FIG. 10 is a plan view of a door structure having a glass opening with the channel members integrated within the trim members in accordance with the invention.

### DETAILED DESCRIPTION OF THE INVENTION

Turning now to the drawings wherein like reference characters refer to like and corresponding parts throughout the several views, a window structure 10 is shown as part of a building structure such as a house having siding 11 and which may have window molding 12. As shown in more detail in FIGS. 2, 3, and 4, an upper trim member 13 is, as typical, mounted on the face of building structure 14 itself, and a lower trim member 15 is mounted below sill member 16 likewise directly to building structure 14. Side trim members, one of which is shown at 17 in FIG. 1, likewise may surround the window or door structure.

In accordance with the invention, upper trim member 13 incorporates an elongated channel member 18, one embodiment of which is seen more clearly in FIGS. 4 and 5, as comprising a back wall 19, side walls 21, and a front wall 22. The front wall has an elongated open slot 23 extending lengthwise of the channel member, and a transverse support plate or flange 24 may form an extension of back wall 19. Trim member 13, which may be of wood or of a synthetic composition sold under the trade name Azek, is first grooved along its length to receive plate 24, and is provided with a cutout along its length to receive the back and a side wall or walls of the channel member. Otherwise, the trim member may be only grooved to receive flange 24 such that the back, sides and front walls of the channel extend outwardly of the trim. The channel member is integrated with the trim member prior to installation of the trim member against the building structure 14 after the window is set in the building. Or, if the trim member is already fastened in place to the building, it can be adapted to incorporate the invention by removing the trim member and grooving along its inner edge to accommodate plate 24 and providing a cutout to provide the back and side wall or walls of the channel as aforedescribed, or only grooved to receive flange 24. The trim member is fastened to the building structure using typical screws 25 or the like. Bolts 26, having heads 27 and bolt shanks 28, are slid within the channels from open ends thereof such that the bolt heads are contained within the channels with their shanks extending through slot 23. The bolt heads may be hexagonal or otherwise rectangular presenting flat surfaces to avoid rotation once slid in place.

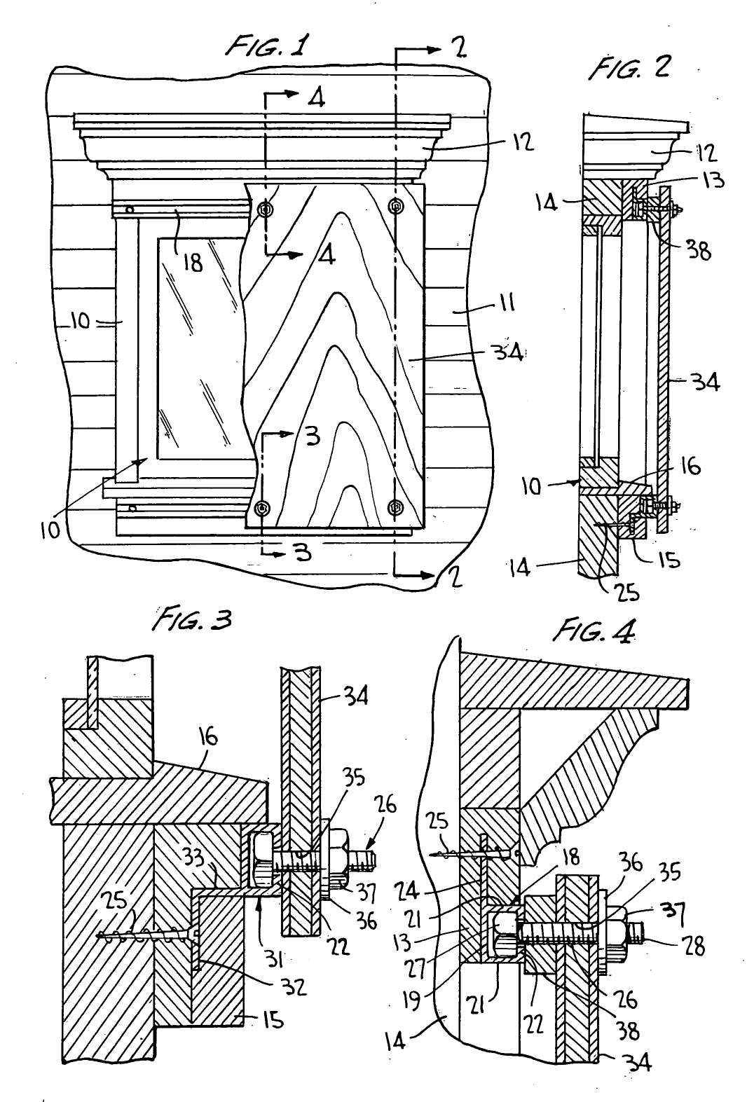

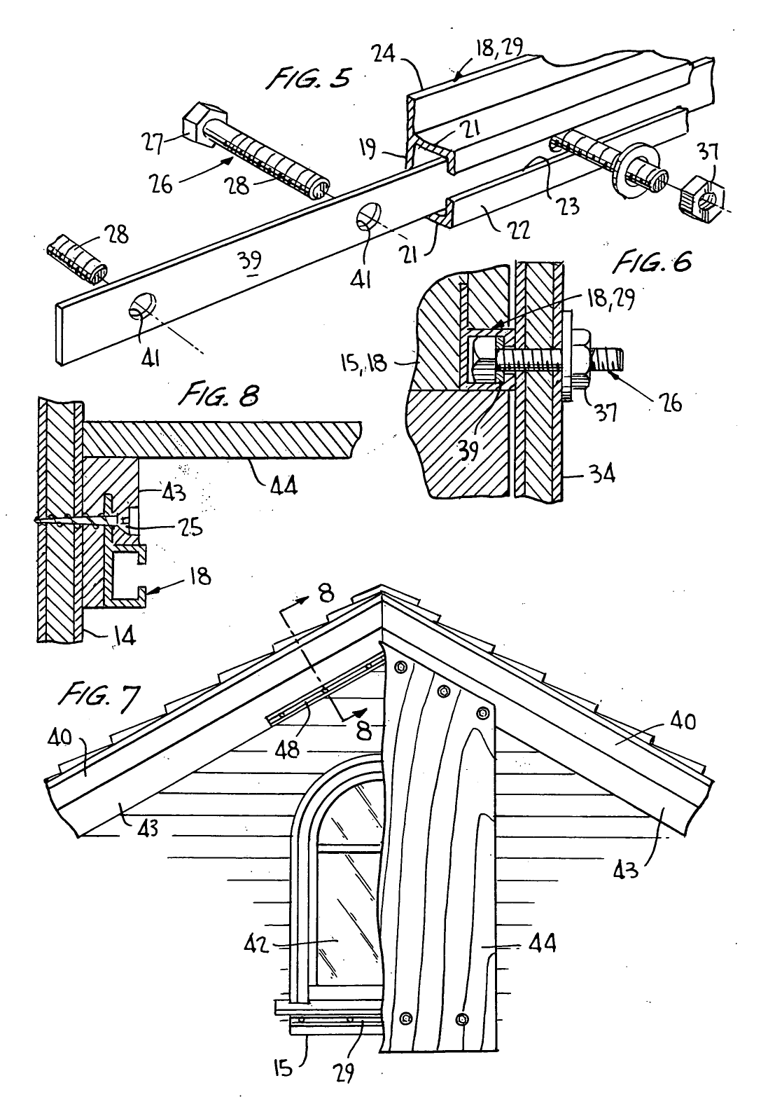

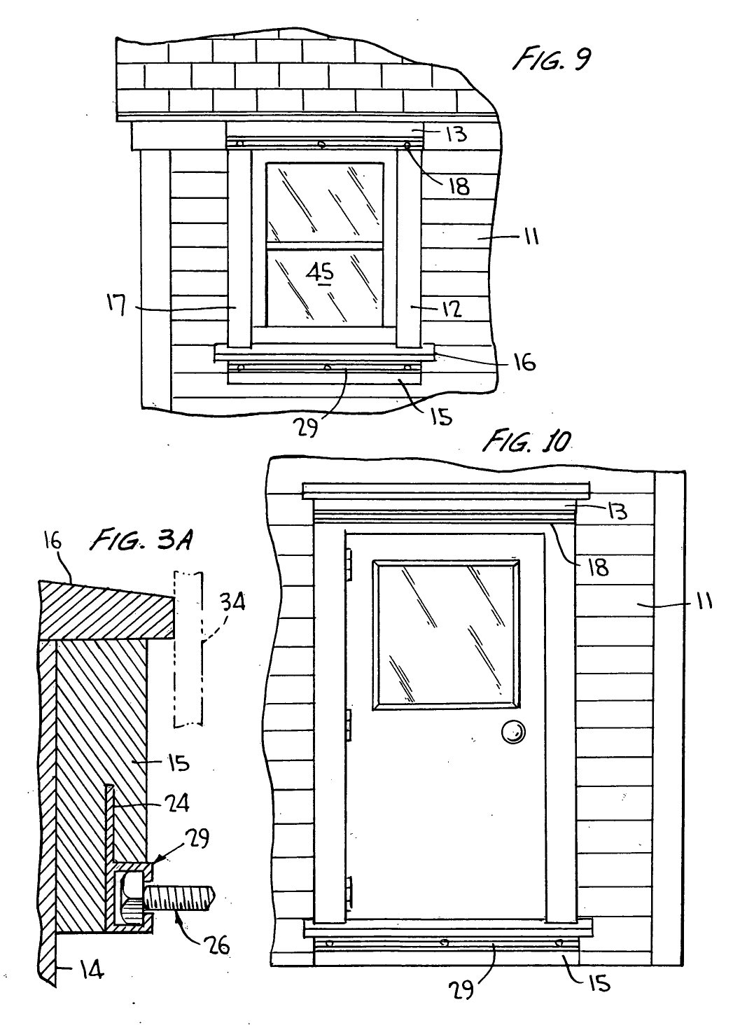

Similarly, a lower channel member 29 is integrated into lower trim member 15 which, as shown in FIG. 3A, is identical to channel member 18. Thus, trim member 15 is grooved along its lower edge for the reception of plate 24 and is provided with a cutout for the reception of the back and a side wall or walls of the channel member, or the trim member is simply grooved to receive flange 24. Bolts 26 are slid along the length of the channel member through one or both open ends thereof with the bolt heads presenting flat surfaces received within the channel while their shanks extend through the channel slot. Otherwise, a lower channel member 31 may be formed as shown in FIG. 3 with its support plate 32 received within a slot provided along an inner edge of the trim member attached to another transverse plate section 33 which may form an extension of a side wall 21 of the channel member. Again, bolts 26 with their heads presenting flat surfaces are slid along the channel member from open ends thereof with their shanks extending through the slots of the channel members, as before.

In order to accommodate sill 16, channel member 31 is dog-legged with plate sections 32, 33 as in FIG. 3 such that when the storm panel 34 is mounted in place the inner face of the panel is spaced slightly from the confronting edge of the sill to avoid any marring. Otherwise, the storm panel, when utilizing the arrangement according to FIG. 3A, simply bears against the outer edge of the sill as shown in phantom outline in FIG. 3A.

Storm panel 34 is provided with apertures 35 at predetermined spaced apart distances along the upper and lower ends of the panel to facilitate mounting the panels in place as the bolt shanks are made to extend through apertures 35 followed by the placement of washers 36, if necessary, over the bolt shanks and nuts 37 tightened down over the threaded bolt shanks 28. To maintain the storm panel 34 parallel to the window pane, a spacer 38 (FIG. 4) suitably apertured can be interposed between the upper channel 18 and the inner face of the storm panel. Otherwise, if window sill 16 does not extend beyond lower trim member 15, spacer 38 can be eliminated, and channel member 31 can be designed such that its plate section 33 is shallower.

For convenience, a bolt spacer plate 39 shown in FIG. 5 may be provided having apertures 41, the spacer plate being slid from one end into the channel member after bolts 26 are first extended through the apertures 41 thereof such that, as shown in place in FIG. 6, the bolt shanks extend through slot 23 to facilitate mounting the storm panel in place. Apertures 41 are spaced apart the same predetermined distance as the spacing of apertures 35 in the storm panel to expedite the mounting of the panel in place as the panel apertures are assured of being in alignment with the bolt shanks during installation. Otherwise, the bolts can be spaced predetermined distances apart equal to the same spacing as the storm panel apertures by the provision of detents or the like providing stop members within the channels, without departing from the invention.

In another embodiment according to the invention, an upper window 42 of a building structure is shown in FIG. 7 as having a domed upper end located near the house roof peak whereupon upper channel members 18 are incorporated within trim members 43 typically provided beneath soffit 44 of the roof structure. Channel member 18 is substantially the same as that described with reference to FIG. 4 in that it is mounted in place using the same fasteners 25 utilized for the trim member itself. Storm panel 44 differs from storm panel 34 only in that its upper end is angled to conform to the soffit shape and upper trim member shape. Otherwise, storm panel 44 is mounted in place in the same manner as described with reference to FIGS. 1 to 4.

FIG. 9 illustrates a window structure 45 substantially the same as window structure 10 of FIG. 1 except that no upper molding is provided. It can be seen that upper and lower trim members 13 and 15 each incorporate upper and lower channel members 18 and 29 similarly as described with reference to FIGS. 4 and 3A.

Lastly, FIG. 10 illustrates an upper door trim member 13 and a lower door trim member 15 incorporating upper channel member 18 and lower channel member 29 employed for mounting a storm panel (not shown) in place similarly as described with reference to FIG. 1.

It can be seen from the aforedescribed that the storm panel mounting assembly according to the invention provides an efficient and streamlined and highly effective assembly for mounting storm panels over glass windows and glass doors of the building structure in an efficient and convenient manner with the minimum use of tools while bearing safety considerations in mind. The channel members are incorporated within the upper and lower trim members which are normally mounted in place onto the building structure prior to installation of the building siding and therefore remain in place even while the storm panels are not in use. The channel members are practically unnoticeable and facilitate quick and easy mounting of the storm panel by simply sliding the headed bolts along the channel length from an open end or ends with the bolt shanks extending through the channel slots and mating with the apertures provided along the upper and lower ends of the storm panel for quickly and efficiently mounting the panel in place to avoid wind damage to the glass of the windows or doors caused by storms.

Obviously, many other modifications and variations are made possible in the light of the above teachings. For example, as referenced hereinabove, locating stops can be provided within the channel members for maintaining the bolts at the same spaced apart distances as the apertures in the storm panels. And, the support plates of the channels can take alternate shapes for being incorporated together with the channel members itself into the trim member, other than shown and described, without departing from the invention. It is therefore to be understood that within the scope of the appended claims the invention may be practiced otherwise than as specifically described.

What is claimed is:

1. An assembly for mounting storm panels on a building structure which includes glass openings comprising window and door structures each having at least an adjacent upper trim member and an adjacent lower trim member mounted directly on an exterior surface of said building structure, wherein each of said storm panels has a plurality of apertures at predetermined spaced apart intervals along at least upper and lower ends thereof, said assembly comprising:
elongated channel members mounted respectively within said upper and lower trim members, each of said channel members having front, side and back walls, each said front wall having an elongated slot extending lengthwise of each said channel member;
a plurality of bolts each having an enlarged head and a shank, said bolts being located within said slots at bolt intervals coincident with said spaced apart intervals of said apertures, each said shank of said bolts extending outwardly through said slots; and
a plurality of a removably attachable fastening elements coupled to said bolt shanks whereby said storm panels overlie said glass openings of said window and door structures.

2. The assembly according to claim 1, wherein each said channel member further has a transversely extending mounting plate received within an open slit in said upper and lower trim members.

3. The assembly according to claim 2, wherein fastening means extend through said mounting plates and into the exterior surface of said building structure.

4. The assembly according to claim 2, wherein each said mounting plate forms an extension of each of said back walls of said channel members.

5. The assembly according to claim 1, wherein said front, side and back walls of said channel members are located within cutouts of said trim members.

6. The assembly according to claim 2, wherein said front, side and back walls of said channel members are located within cutouts of said trim members.

7. The assembly according to claim 1, wherein said bolts are located within said slots at said bolt intervals by bolt spacers located within said slots.

8. The assembly according to claim 7, wherein said bolt spacers each comprise an elongated strip within each of said slots, each said strip having a plurality of apertures through which said bolts extend.

9. The assembly according to claim 2, wherein each said mounting plate lies parallel to each of said back walls of said channel members.
